(19) United States
(12) Patent Application Publication
(10) Pub. No.: US 2005/0130054 A1
(43) Pub. Date: Jun. 16, 2005

(54) Toners and inks prepared using polyolefin waxes

(75) Inventors: Xiaoying Yuan, Houston, TX (US); Paul K. Hanna, Sugar Land, TX (US); John Shelley, Sapulpa, OK (US); William P. Cottom, Mounds, OK (US); David D. Truong, Stafford, TX (US); Tom J. Clark, Myakka City, FL (US)

Correspondence Address: MADAN, MOSSMAN & SRIRAM, P.C., 2603 AUGUSTA, SUITE 700, HOUSTON, TX, 77057, US

(73) Assignee: Baker Hughes Incorporated, Houston, TX (US)

(21) Appl. No.: 10/992,323

(22) Filed: Nov. 18, 2004

Related U.S. Application Data
(60) Provisional application No. 60/525,000, filed on Nov. 25, 2003.

(51) Int. Cl. G03G 9/08

(52) U.S. Cl. 430/108.8

(57) ABSTRACT

Disclosed are wax based inks for phase change/hot melt inkjet printing or thermal transfer printing applications. Also disclosed are waxes useful for toners for use in electrostatographic printing applications. Both materials are prepared using a wax having a narrow melting range. The narrow melting range of the wax reduces energy requirements in printing applications. The use of the waxes also promotes release for high speed printing and especially promotes fast drying in wax based ink applications.

### CROSS REFERENCE TO RELATED APPLICATIONS

This application claims priority from U.S. Provisional Patent Application No. 60/525,000 filed on Nov. 25, 2003.

### BACKGROUND OF THE INVENTION

1. Field of the Invention

The present invention relates to toners for use in electrostatographic printing and hot melt inks for use in thermal inkjet printing.

2. Background of the Art

It is known to prepare polyolefin polymers for many applications. For example, U.S. Pat. No. 5,707,722 to Akimoto, et al., discloses preparing a toner composed of a resin, a colorant, and a releasing agent wherein the releasing agent is a polyolefine (sic.) polymer synthesized in the presence of a metallocene catalyst. U.S. Pat. No. 5,604,573 to Endo, et al., discloses preparing a developing apparatus for developing an electrostatic image using a resin that can be an isotactic polypropylene obtained by using metallocene polymerization.

Use of polyolefm polymers in, for example, toners as lubricants is reported in several patents. U.S. Pat. No. 6,063,536 to Ikeyama, et al., claims a toner including a propylene-based copolymer wax wherein the propylene-based copolymer has a weight average molecular weight determined by gel permeation chromatography of from 3,000 to 50,000, a melting point determined by differential scanning calorimetry of from 120° C. to 140° C., and a propylene content of at least 90% by mole of propylene. U.S. Pat. No. 6,052,940 to Fukuzawa, et al., claims a toner for electrophotography, the toner at least containing a coloring agent, a binder resin, a charge control agent, and a functioning agent, wherein a low molecular weight polyolefin wax comprising co-polymers of alpha olefins with cyclo-olefins obtained by using a metallocene type polymerization catalyst is the functioning agent. U.S. Pat. No. 5,677,409 to Inoue, et al., claims a syndiotactic polypropylene wax having a syndiotactic pentad fraction of at least 0.7, a melting point in a range of 120-170° C. as measured by a differential scanning calorimeter.

In U.S. Pat. No. 6,629,750 to Ciordia, it is disclosed that in a thermal inkjet printing system, ink flows along ink channels from a reservoir into an array of vaporization chambers. Associated with each chamber are a heating element and a nozzle. A respective heating element is energized to heat ink contained within the corresponding chamber. The corresponding nozzle forms an ejection outlet for the heated ink. As the pen moves across the media sheet, the heating elements are selectively energized causing ink drops to be expelled in a controlled pattern. The ink drops dry on the media sheet shortly after deposition to form a desired image.

U.S. Pat. No. 6,642,408 to Batlaw, et al., discloses that wax-based inkjet inks are generally solid at room temperature and subsequently heated to a temperature above their melting point and maintained at a temperature above about 150° C. wherein the composition must exhibit fluid physical properties required for inkjet printing methods. Thus, these inkjet ink composition generally comprise two component types: colorants and vehicles for the colorants. The vehicle often consists of a blend of polymers which function to control the viscosity temperature profile and balance the performance of the ink in the print head with the performance of the ink on the paper. Such polymers tend to be based upon fatty acids, urethanes, and natural and/or synthetic waxes.

U.S. Pat. No. 5,546,114 to Tait, et al., discloses that exemplary wax base components that may be used independently or in combination to form a base for a thermal wax transfer ink include vegetable waxes such as camauba wax, Japan wax, ouricury wax, esparts wax and the like. Animal waxes such as bees wax, insect wax, shellac wax, spermaceti wax and the like; petroleum waxes such as paraffin wax, microcrystalline wax, ester wax, oxidized wax and the like; mineral waxes such as montan wax, azocerite, ceresine and the like; higher fatty acids such as palmitic acid, stearic acid, margaric acid, behenic acid and the like; higher alcohols such as palmityl alcohol, stearyl alcohol, behenyl alcohol, margaryl alcohol, myricyl alcohol, eicosanol and the like; higher fatty acid esters such as cetyl palmirate, myricyl palmitate, cetyl stearate, myricyl stearate and the like; amides such as acetamide, propionic acid amide, palmitic acid amide, stearic acid amide, oleic acid amide, amide wax and the like; polyamides; primary and secondary fatty acid amides; rosin derivatives such as ester gum, rosin maleic acid resin, rosin phenol resin, hydrogenated rosin and the like; and rosin esters are also disclosed to be useful. This reference further lists macromolecular compounds having a softening point of from about 40° C. to about 120° C., such as phenol resin, terpene resin, cyclopentadiene resin, aromatic resin and the like; higher amines such as stearylamine, behenylamine, palmitinamine and the like; polyethylene oxides such as polyethylene glycol 4000, polyethylene glycol 6000 and the like; and the like to be useful.

### SUMMARY OF THE INVENTION

In one aspect, the present invention is a toner comprising a resin, a colorant, and a release agent wherein the release agent is a composition comprising a polyolefin wax having a melting point of from about 50° C. to about 120° C. and a melting range of from about 5° C. to about 65° C.

In another aspect, the present invention is a hot melt ink useful for phase change/hot melt inkjet printing or thermal transfer printing comprising a colorant and an ink vehicle wherein the ink vehicle includes a polyolefin wax having a melting point of from about 50° C. to about 120° C. and a melting range of from about 5° C. to about 65° C.

### DESCRIPTION OF THE PREFERRED EMBODIMENTS

In one embodiment, the present invention is a toner comprising a resin, a colorant, and a release agent wherein the release agent is a composition comprising a polyolefin wax. The toners of the present invention are particularly useful in the fields of electrostatographic and thermal inkjet printing. Electrostatographic printing is also often referred to as photocopying, electrophotography, copying, or duplicating. This same process is used in large copiers and printers and small home-office printers, commonly referred to as “Laser Printers”, and the like.

In electrostatographic printing, an electrostatic image is formed on a photoreceptor by charging and exposure and then image developed with toner; developed image are then transferred to a medium, such as paper. After the image is transferred, it is then exposed to heat, pressure, or both wherein the resin, sometimes referred to as the binder resin, serves to bind the image to the paper. One of the functions of the release agent is to prevent the high temperature toner offset that cause toner adhere to the photoreceptor and fixing roll.

The hot melt inks of the present invention include a colorant and an ink vehicle wherein the ink vehicle includes a polyolefin wax. The function of the ink vehicle is to act as continuous phase containing the colorant. The wax of the ink vehicle can also function to protect the image after printing from moisture. These inks are sometimes referred to as phase change inks which are used in phase change (hot melt) printing. To reduce energy and enable low temperature fixing, a wax having a relatively low melting point and a narrow melting range is desirable for the toner and the hot melt ink applications.

The waxes useful with the present invention can be prepared using any polyolefin, but preferably are prepared using ethylene and propylene. The polyolefins can be polymerized using any method known to those of ordinary skill in the art of preparing waxes to be useful. For example, in one embodiment, the waxes of the present invention are prepared using a metallocene catalyst. Metallocene catalysts are, in general, organometallic coordination compounds obtained as a potentially substituted cyclopentadienyl derivative of a transition metal or metal halide. Exemplary are dicylcopentadienyl-metals with the general formula (C₅H₅)₂M, dicylcopentadienyl-metal halides with the general formula (C₅H₅)₂MX₁₋₃, and monocylcopentadienyl-metal compounds with the general formula (C₅H₅)₂MR₁₋₃, where R is CO, NO, a halide group, an alkyl group, and the like, M is a metal and X is a halide.

For the purposes of the present invention, the metallocene catalysts which can be used with present invention include any that can be used to prepare wax. Preferably, the catalysts are substituted zirconocenes for polypropylene. Most preferably, the catalysts that are used with the present invention are those having the general formula:

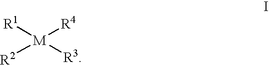

Inherent in this formula are also the following formulae:

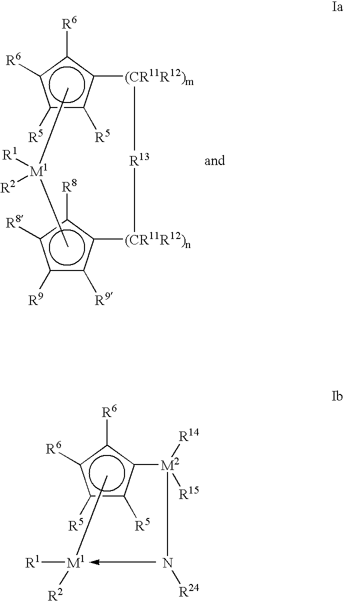

In the formulae, M¹ is a metal of group IVA, VA or V1A of the Periodic Table, for example titanium, zirconium, hafnium, vanadium, niobium, tantalum, chromium, molybdenum, tungsten, preferably titanium, zirconium and haffiium or inner transition metals e.g., samarium.

R¹ and R² are identical or different and are each a hydrogen atom, a C₁-C₁₀, preferably C₁-C₃-alkyl group, in particular methyl, a C₁-C₁₀, preferably C₁-C₃-alkoxy group, a C₆-C₁₀, preferably C₆-C₈-aryl group, a C₆-C₁₀, preferably C₆-C₈-aryloxy group, a C₂-C₁₀ preferably C₂-C₄-alkenyl group, a C₇-C₄₀, preferably C₇-C₁₀-arylalkyl group, a C₇C₄₀, preferably C₇C₁₂-alkylaryl group, a C₈-C₄₀, preferably C₈-C₁₂-arylalkenyl group or a halogen atom, preferably chlorine. R³ and R⁴ are identical or different and are each a monocyclic or polycyclic hydrocarbon radical that can form a sandwich structure with the central atom M¹. R³and R⁴ are preferably cyclopentadienyl, indenyl, benzindenyl or fluorenyl, where the base structures can also bear additional substituents or be bridged to one another. In addition, one of the radicals R³ and R⁴ can be a substituted nitrogen atom, where R²⁴ is as defined for R¹⁷ and is preferably methyl, t-butyl or cyclohexyl.

R⁵, R⁶, R⁸, R^{8′}, R⁹ and R^{9′} are each identical or different and are each a hydrogen atom, a halogen atom, preferably a fluorine, chlorine or bromine atom, a C₁-C₁₀, preferably C₁-C₄-alkyl group, a C₆-C₁₀, preferably C₆-C₈-aryl group, a C₁-C₁₀, preferably C₁-C₃-alkoxy group, an —NR₂¹⁶—, —SR¹⁶—, —OSiR₃¹⁶—, —SiR₃¹⁶—, or —PR₂¹⁶, radical, where R¹⁶ is a C₁-C₁₀, preferably C₁-C₃-alkyl group or C₆-₁₀, preferably C₆-C₈-alkyl group, or in the case of Si-or P-containing radicals is also a halogen atom, preferably a chlorine atom, or two adjacent radicals R⁵, R⁶, R⁸, R⁹ or together with the carbon atoms connecting them form a ring. Particularly preferred ligands are the substituted compounds of the base structures indenyl, benzindenyl, fluorenyl and cyclopentadienyl. R¹³ is: 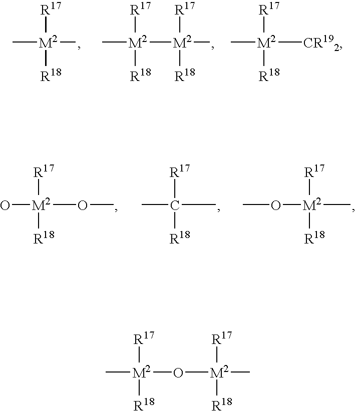
═BR¹⁷, ═AlR¹⁷, —Ge—, —Sn—, —O—, —S—, ═SO, ═SO₂═NR^{15′} ═CO, ═PR¹⁵ or ═P(O)R¹⁵, where R¹⁷, R¹⁸ and R¹⁹ are identical or different and are each a hydrogen atom, a halogen atom, a C₁-C₃₀, preferably C₁-C₄-alkyl group, in particular a methyl group, a C₁-C₁₀-fluoroalkyl group, preferably a CF₃ group, a C₆-C₁₀-fluoroaryl group, preferably a pentafluorophenyl group, a C₆-C₁₀, preferably C₆-C₈-aryl group, a C₁-C₁₀, preferably C₁-C₄-alkoxy group, in particular a methoxy group, a C₂-C₁₀, preferably C₂-C₄-alkenyl group, a C₇-C₄₀, preferably C₇-C₁₀-arylalkyl group, a C₈-C₄₀, preferably C₈-C₁₂-arylalkenyl group or a C₇-C₄₀,-, preferably C₇-C₁₂-alkylaryl or R¹⁷ and R¹⁸ or R¹⁷ and R¹⁹, in each case together with the atoms connecting them, form a ring.

M² is carbon, silicon, germanium or tin, preferably silicon, germanium, or a covelent bond.

R¹³ is preferably ═CR¹⁷R¹⁸, ═SiR¹⁷R¹⁸, ═GeR¹⁷R¹⁸, —O—, —S—, ═SO, PR¹⁷or ═P(O)R¹⁷.

R¹¹ and R¹² are identical or different and are as defined for R¹⁷.

The symbols m and n are identical or different and are zero, 1 or 2, preferably zero or 1, where m plus n is zero, 1 or 2, preferably zero or 1.

R¹⁴ and R¹⁵ are as defined for R¹⁷ and R¹⁸.

Examples of suitable metallocenes are the rac isomers of:ethylenebis-1-(2-methyltetrahydroindenyl)zirconium dichloride, ethylenebis-1-(4,7-dimethyl indenyl)zirconium dichloride, ethylenebis-1-(2-methyl-4-phenylindenyl)zirconium dichloride, ethylenebis-1-(2-methyl-4,5-benzindenyl)zirconium dichloride, etbylenebis-1-(2-methyl-4,5-benzo-6,7-dihydroindenyl) zirconium dichloride, ethylenebis-1-(2-methylindenyl)zirconium dichloride, ethylenebis-1-tetrabydroindenylzirconium dichloride, and also the alkyl or aryl derivatives of each of these metallocene dichlorides.

To activate the single-center catalyst systems, suitable cocatalysts are used. Suitable cocatalysts for metallocenes of the formula I are organoaluminum compounds, in particular aluminoxanes, or aluminum-free systems such as R_{X}²²NH_{4-X}BR₄²³, R_{X}²²,

PH_{4-X}BR₄²³, R₃²²CBR₄²³ or BR²³. In these formulae, x is from 1 to 4, the radicals R²² are identical or different, preferably identical, and are C₁-C₁₀-alkyl or C₆-C₁₈-aryl or two radicals R²² together with the atom connecting them form a ring, and the radicals R²³ are identical or different, preferably identical, and are C₆-C₁₈-aryl which may be substituted by alkyl, haloalkyl or fluorine. In particular, R²² is ethyl, propyl, butyl or phenyl and R²³ is phenyl, pentafluorophenyl, 3,5-bis(trifluoromethyl)phenyl, mesityl, xylyl or tolyl.

These cocatalysts are particularly suitable in combination with metallocenes of the formula I when R¹ and R² are each a C₁-C₁₀-alkyl group or an aryl or benzyl group, preferably a methyl group. Derivative formation to give the metallocenes of the formula I can be carried out by literature methods, for example by reaction with alkylating agents such as methyl lithium (cf. Organometallics 9 (1990) 1359; J. Am Chem. Soc. 95 (1973) 6263).

In addition, a third component is frequently necessary to provide protection against polar catalyst poisons. Organo-aluminum compounds such as triethylaluminum, tributylaluminum and others, and also mixtures, are suitable for this purpose. Depending on the process, supported single-center catalysts can also be used. Preference is given to catalyst systems for which the residual contents of support material and co-catalyst in the product do not exceed a concentration of 100 ppm.

The waxes useful with the present invention can also be prepared using a Ziegler-Natta catalyst. Such catalysts are well known in the industry. The Ziegler-Natta catalysts in the simplest form are comprised of a titanium, or other transition metal component and a co-catalyst component comprising at least one organometallic compound.

In the practice of the present invention, the waxes useful with the present invention can be prepared wherein the components of the catalyst can be introduced in any manner known in the art. For example, the catalyst components can be introduced directly into a fluidized bed reactor in the form of a solution, slurry or dry free flowing powder. The catalyst can also be used in the form of a deactivated catalyst, or in the form of a prepolymer obtained by contacting the titanium component with one or more olefins in the presence of a co-catalyst. The Ziegler-Natta catalyst can optionally contain magnesium and/or chlorine. Such magnesium and chlorine containing catalysts may be prepared by any manner known in the art.

The co-catalyst component of the Ziegler-Natta catalyst can be any organometallic compound, or mixtures thereof, that can activate the titanium metal component of the Ziegler-Natta catalyst in the polymerization of olefins. In particular, the organometallic co-catalyst compound that is reacted with the titanium component contains a metal selected from lithium, magnesium, copper, zinc, aluminum, silicon and the like, or mixtures thereof. Exemplary compounds include the trialkylaluminum compounds and dialkylaluminum monohalides. Examples include trimethylaluminum, triethylaluminum, trihexylaluminum, dimethylaluminum chloride, and diethylaluminum chloride.

The titanium component, with or without co-catalyst, may be deposited on a carrier. In so doing, there may be used as the carrier any catalyst carrier compound known in the art. Exemplary carriers are magnesium oxides, magnesium oxyhalides and magnesium halides, particularly magnesium chloride. The catalyst, with or without the carrier, may be supported on a solid porous support, such as silica, alumina and the like. The Ziegler-Natta catalyst may contain conventional components in addition to the titanium component and the organometallic co-catalyst component. For example, there may be added any internal or external electron donor(s) known in the art, and the like.

The waxes useful with the present invention can be prepared by free radical initiated polymerization, which is well known to those of ordinary skill in the art of preparing waxes. Other methods of preparing such waxes include using late transition metal catalysts systems acyclic diene metathesis processes and ring opening metathesis processes. An example of ADMET is discussed in the paper titled Precise Controlled Methyl Branching In Polyethylene Via Acyclic Diene Metathesis (ADMET) Polymerization, 33 Macromolecules 3781 (2000). The waxes useful with the present invention can be prepared by fractional crystallization.

While any method described above can be used to the prepare the waxes useful with the present invention, additional processing of the waxes so prepared may be required in order to produce waxes having melting points and melting ranges suitable for the toners and inks of the present invention. For example, in one route to producing a wax that can be used in the toners and inks of the present invention, a wax can be prepared using a Ziegler-Natta catalysts system, and then further processed using preparative liquid chromatography wherein the lower and higher molecular weight fractions are separated leaving wax having a melting point of from about 50° C. to about 120° C. and a melting range of from about 5° C. to about 65° C.

Another route to preparing a wax useful with present invention includes preparing a wax using a metallocene catalyst system and then distilling the wax. A fraction of the wax having a constant distillation temperature is prepared, the lower and higher boiling components having been separated. In a similar process, a metallocene catalyst system is used to prepare a wax that is then subjected to solvent fractionation to prepare a wax having a melting point of from about 50° C. to about 120° C. and a melting range of from about 5° C. to about 65° C.

The polyolefin waxes useful with the present invention are partially crystalline. The crystallinity of a wax can be defined in several ways. For the purposes of the present invention, the waxes useful with the present invention include those that have a melting point, by DSC, of from about 50° C. to about 120° C. and a melting range of from about 5° C. to about 65° C. Preferably, the waxes useful with the present invention have a melting point of from about 50° C. to about 120° C. and a melting range of from about 6° C. to about 30° C. In another embodiment of the present invention, the waxes useful with the present invention have a melting point of from about 55° C. to about 100° C. and a melting range of from about 6° C. to about 25° C. The melting point is measured according ASTM-3418-99. The melting range is defined by subtracting the temperature at completion of transition from the temperature at the onset of transition, as performed using the procedures set forth in ASTM D3418-99.

The waxes useful with the present invention are preferably prepared with ethylene and propylene but other olefins can also be used. Other olefins that can be used, either alone or as co-monomers in the waxes include: alpha olefins including butene, pentene, hexene, octene, styrene, isobutylene, and the like; hindered dienes including butadiene, isoprene, chloroprene, cyclics including norbornene or norbomadiene and the like.

The toners of the present invention include a resin. Theses resins, also referred to as binder resins, can include styrene polymers, e.g., polystyrene, styrene-acrylate copolymer resins, polyester resins, and the like. The toners of the present invention include a binder resin that can be the reaction product of a conventional resin and a polypropylene polyfunctional polymer, an isotactic polypropylene homopolymer derivative or an isotactic polypropylene copolymer derivative or syndiotactic polypropylene. The resins may also be obtained through the polycondensation reaction of polyoxypropylene (2,2)-2,2-bis (4-hydroxyphenyl) propane, fumaric acid, octynel succinic anhydride, terephthalic acid and alcohol derivative of polypropylenes. Any resin that is known to those of ordinary skill in the art of preparing toners to be useful can be used with the present invention.

The toners of the present invention can be obtained through the addition of various pigments, charge control agents, magnetic powders and other optional components to the binder resin prepared with polymers of the present invention. Resins are further processed by methods known to those of ordinary skill in the art of preparing resins, for example, the melt of the resin described above is subsequently dispersed through the use of a super mixer, Danbury mixer, roll mill, kneader or extruder. Rough pulverization of the cooled melt is carried out through the use of a cutter mill, hammer mill or similar process; fine pulverization with a jet mill; or classifying with a wind power classifier.

Normally, a surface treatment of the resulting resin product with various additives is included as a finishing step of the process. Representative examples of the above mentioned binder resin includes styrene resins, styrene-acrylic copolymer resins, polyester resins, polyethylene resins, epoxy resins, silicon resins, polyamide resins, polyurethane resins and the like. Representative examples of the above mentioned pigment includes carbon black, nigrosine, aniline blue, charcoal blue, chromium yellow, ultramarine blue, dupone oil red, quinine yellow, methylene blue chloride, phtalocyanine blue, malachite green ocsalate, lamp black, rose bengal mixture thereof and the like. The ratio of the pigments is such that the corresponding image is visibly and measurably sufficient. Representative examples of the magnetic powder includes metals having strong magnetic properties, such as ferrites, magnetite, iron, cobalt, nickel, alloys thereof and compounds comprising these elements; and alloys that do not comprise strong magnetic elements but shows strong magnetic properties upon being heat treated.

The magnetic powders referenced above are dispersed within a resin with an average weight of 20 to 70 parts of magnetic powders to 100 parts of the binder resin. The two-component developer can be obtained through mixing of the toner with carriers such as ferrite, steel and iron carriers. The toner utilized in a two-component system typically contains magnetic powders that are dispersed with an average weight of 0.1 to 10 parts to 100 parts of the binder resin.

In preparing the toners of the present invention, it is sometimes desirable to use degassing additives to release entrapped gases during extrusion and fusion of the toners and powder coatings. Degassing agents are additives that lower the surface tension, allowing entrapped gases to escape during extrusion and fusion steps. It should be noted that if gas is unable to escape during fusing, the gas can form bubbles in the toner or powder coating. The bubbles will often break which can leave the film surface pin holed and cratered.

In general, a toner has been produced by melting and mixing a colorant, a charge control agent, an offset preventing agent such as polypropylenes and thermoplastic resin, uniformly dispersing them in the thermoplastic resin to prepare a composition, grinding the composition and then classifying the ground product. Besides, in the grinding process, it is difficult to uniformly disperse solid fine particles such as the colorant, charge control agent and offset preventing agent in the thermoplastic resin. The unevenly dispersed state of the solid fine particles may decrease the image density. Also, the uneven dispersion of these solid fine particles in the grinding process adversely affects the flowability, triboelectrification properties and the like of the resulting toner to great extent and influences properties of the toner, such as developing characteristics and durability.

In order to reduce energy consumption and particle size, chemical prepared toner technologies including suspension polymerization, emulsion polymerization and aggregation, microencapsulation, dispersion polymerization and others, are developed. In preparing a chemically produced toner present in this invention, the toner include a resin styrene polymers, e.g., polystyrene, styrene-acrylate copolymer resins, polyester resins, and the like; colorant, release agent e.g. polyethylene wax, and polypropylene wax and other additives including charge control agent and surface additive such as silica, etc.

In general, polyethylene or polypropylene waxes used with present invention for chemically prepared toners are dispersed into water with ionic or nonionic surfactants; preferably dispersed into water with nonionic surfactants, then aggregated with toner resins during aggregation process. In addition, polyethylene and polypropylene waxes used with present invention for chemically prepared toners are dispersed or dissolved in to monomers or solvents or as seed polymer and then form toner particle by emulsion or suspension polymerization, after polymerization the waxes uniformly mixed with toner resin or encapsulated in the toner resins. The chemical toner processes are prefer low melting temperature and sharp melting release agent such as we proposed this invention.

In the hot melt inks of the present invention, the ink can be formed by combining the ink vehicle composition with compatible subtractive primary colorants. For example, the subtractive primary colored phase change inks of this invention can include four component dye colors, namely, cyan, magenta, yellow and black. U.S. Pat. Nos. 4,889,506; 4,889,761; and 5,372,852 teach that the subtractive primary colorants employed typically may comprise dyes from the classes of Color Index (CI.) Solvent Dyes, Disperse Dyes, modified Acid and Direct Dyes, and a limited number of Basic Dyes. The colorants can also include pigments as exemplified in U.S. Pat. No. 5,221,335. Any colorants useful for preparing hot melt inks for thermal printing can be used with the present invention.

In addition to the colorant and ink vehicle already described above, the wax based inks of the present invention can include other additives. For example, the hot melt inks of the present invention can include from about 0 to about 40 weight percent of a tackifier, from about 0 to about 25 weight percent of a plasticizer, and from about 0 to about 10 weight percent of a viscosity modifying agent or any combination of these.

The waxes useful with the present invention may or may not have a residual unsaturation that can be utilized to form derivatives that can facilitate the use of the waxes with the present inventions. For example, a wax useful with the present invention can be functionalized to terminate in a carboxyl, hydroxyl, epoxy or amine group. One or more of these functionalized waxes can be employed to, for example, increase the compatibility of the functionalized wax with the resin in a toner.

The narrow melting range of the waxes useful with the present invention permits the toner to effectively broaden the range of color reproduction and improve phase chase printing speed and color registration. This is because that a narrower melting range provides fast drying speed upon temperature change. For toners, it is desirable that the release agent melts and solidifies nearly instantaneously, which will improve printing speed and limit offset during fixing step. For hot melt inks, a sharp melting range will improve printing speed, color registration and provide high quality color printing. An advantage of the present invention over the prior art is that the waxes useful with the present invention can be melted under low energy because an excess of energy is not needed to melt the higher melting components that are present in the waxes conventionally used in toners. For hot melt inks, the ink vehicle can be melted with less energy because an excess of energy is not needed to liquefy the higher boiling components found in waxes conventionally used with inks used in thermal inkjet printing. The narrow melting range and resultant fast phase changes of the waxes useful with the present invention also allow for high speed printing and fast drying hot melt inks.

### EXAMPLES

The following examples are provided to illustrate the present invention. The examples are not intended to limit the scope of the present invention and they should not be so interpreted. Amounts are in weight parts or weight percentages unless otherwise indicated.

### Hypothetical Example I

An inert 1 liter reactor is charged with 45 g of toluene and 35 g of 1-hexene. The reactor is heated to 40° C. and pressurized to 5 bar with propylene. 7.1 mg of a bridged indenyl-cyclopentadienyl zirconocene catalyst precursor is dissolved in 1 ml of toluene then 6 ml of aluminoxane is added. The polymerization is initiated by the addition of the catalyst solution to the reactor. The temperature and pressure are held constant. Propylene is added as needed. An additional 12 g batch of 1-hexene is added halfway through the reaction. After 60 minutes the reaction is quenched by the addition of isopropanol. The solvent is removed under vacuum and the product drained as a melt. The product weight is 200 g. The DSC peak melting point is 78° C. The onset of melting is 50° C. and melting is complete by 103° C.

This wax is admixed with a resin and a colorant to produce a toner. This wax is admixed with a colorant to form a hot melt ink.

### Hypothetical Example II

1.6g of 12-Methyl-1,22-trieicosodiene is combined with 0.028 g of Grubbs benzylidene catalyst. The tacky rubbery polymer is removed from its original flask, sliced into smaller pieces, and placed into a high pressure glass walled reactor with a threaded top and equipped with a disposable magnetic stir bar. The unsaturated polymer and 2.8 g of silica gel are kneaded. The three substances are kneaded, mixed, and formed into a ball-like structure using a spatula. Finally 20 mL of dry toluene is added. The reaction vessel is then sealed with a Teflon cap affixed with a high-pressure valve attachment and pressure gauge. The reaction vessel is removed from the dry box, connected to a hydrogen tank, and charged with 125 psig of H₂. The reaction is then stirred and heated at 80-85° C. for 48 hours then cooled to room temperature. The hydrogenated polymer is obtained by filtration of the silica and evaporation of the reaction solvent under reduced pressure. The polymer is then dried under vacuum overnight. The polymer is then dissolved in toluene and precipitated into cold methanol. The yield is 77%. The DSC melting point is 62° C. The onset of melting is 57° C. and the melting is complete by 63° C.

### Example III

Several waxes are tested for melting point and melting ranges. The results are shown below in the Table.

TABLE

| | | Melting Peak | Completion T | |
|---|---|---|---|---|
| | Onset T (C) | T (C) | (C) | T_{c}-Tₒₙₛₑₜ |
| Paraffin*¹ | 10 | 56 | 85 | 75 |
| Polywax | 20 | 70 | 83 | 63 |
| Distilled | 65 | 82 | 86 | 21 |
| Polyethylene | | | | |
| Polymer 1 | | | | |
| Distilled | 58 | 74 | 78 | 20 |
| Polyethylene | | | | |
| Polymer 2 | | | | |
| Acyclic Diene | 57 | 62 | 63 | 6 |
| Metathesis | | | | |
| Polyethylene | | | | |
| Sanyo 550*² | 90 | 136 | 145 | 55 |
| Metallocene | 52 | 78 | 100 | 48 |
| Polypropylene | | | | |

*Not an embodiment of the present invention.
¹This paraffin wax is principally composed of normal alkanes obtained by distillation from crude oil. It is typically 40-90 wt % normal alkanes with the remainder C18-C36 isoalkanes and cycloalkanes.
²A polypropylene wax.

### COMMENTS REGARDING THE EXAMPLES

Polywax, and distilled, metallocene and metathesis waxes have sharper melting ranges than similar waxes prepared using standard processes. Metallocene catalyzed polymerization methods can be used to produce low melting temperature polypropylenes with sharper melting ranges than conventional paraffin waxes.

1. A toner comprising a resin, a colorant, and a release agent wherein the release agent is a composition comprising a polyolefin wax having a melting point of from about 50° C. to about 120° C. and a melting range of from about 5° C. to about 65° C.

2. The toner composition of claim 1 wherein the polyolefin wax has a melting point of from about 50° C. to about 120° C. and a melting range of from about 6° C. to about 30° C.

3. The toner composition of claim 2 wherein the polyolefin wax has a melting point of from about 55° C. to about 100° C. and a melting range of from about 6° C. to about 25° C.

4. The toner composition of claim 1 wherein the toner composition additionally comprises a component selected from the group consisting of pigments, charge control agents, magnetic powders, and mixtures thereof.

5. The toner composition of claim 1 wherein the polyolefin wax is an amine functionalized wax and has increased compatibility with the resin.

6. A toner composition of claim 1 wherein the polyolefin wax is produced using a metallocene catalyst.

7. A toner composition of claim 1 wherein the polyolefin wax is produced using a Ziegler-Natta catalyst.

8. The toner composition of claim 1 wherein the wax is produced using a late transition metal catalyst system.

9. The toner composition of claim 1 wherein the wax is produced using an acyclic diene metathesis processes and ring opening metathesis process.

10. The toner composition of claim 1 wherein the wax is produced using a distillation, chromatographic, or solvent fractionation process or fractional crystallization.

11. A hot melt ink useful for phase change/hot melt inkjet printing or thermal transfer printing comprising a colorant and a colorant vehicle wherein the colorant vehicle includes a polyolefin wax having a melting point of from about 50° C. to about 120° C. and a melting range of from about 5° C. to about 65° C.

12. The hot melt ink of claim 11 wherein the polyolefin wax has a melting point of from about 50° C. to about 120° C. and a melting range of from about 6° C. to about 30° C.

13. The hot melt ink of claim 12 wherein the polyolefin wax has a melting point of from about 55° C. to about 100° C. and a melting range of from about 6° C. to about 25° C.

14. The hot melt ink of claim 11 wherein the polyolefin wax is an amine functionalized wax and has increased compatibility with the colorant.

15. A hot melt ink of claim 11 wherein the polyolefin wax is produced using a metallocene catalyst.

16. A hot melt ink of claim 11 wherein the polyolefin wax is produced using a Ziegler-Natta catalyst.

17. The hot melt ink of claim 11 wherein the wax is produced using a late transition metal catalysts system.

18. The hot melt ink of claim 11 wherein the wax is produced using an acyclic diene metathesis processes and ring opening metathesis process.

19. The hot melt ink of claim 11 wherein the wax is produced using a distillation, chromatographic, or solvent fractionation process or fractional crystallization.
